(19) United States
(12) Patent Application Publication
(10) Pub. No.: US 2024/0397585 A1
(43) Pub. Date: Nov. 28, 2024

(54) INDUCTION HEATING DEVICE FOR STATIONARY OR MOVING MATERIAL

(71) Applicant: E-WENCO S.R.L., Legnano MI (IT)

(72) Inventors: Chiara Cremonesi, Legnano MI (IT); Davide Stefano GUERRA, Legnano MI (IT); Amos Duca ROGIANI, Legnano MI (IT)

(21) Appl. No.: 18/699,328

(22) PCT Filed: Oct. 17, 2022
(86) PCT No.: PCT/EP2022/078872

§ 371 Date: Apr. 8, 2024

(30) Foreign Application Priority Data
Oct. 18, 2021 (IT) 102021000026591

(51) Int. Cl. H05B 6/10

(52) U.S. Cl. CPC H05B 6/107; H05B 6/108

(57) ABSTRACT

An induction heating method and device for solid, liquid and/or gaseous materials in motion or in stationary conditions are disclosed. This type of induction heating devices can be integrated into machinery or household appliances, for civil, professional or industrial use and offers large heating surfaces and very high electromagnetic-thermal transduction efficiency.

### FIELD OF THE INVENTION

The present invention relates to an induction heating device comprising at least one inductor element, at least two monolithic or multilayer induced elements and at least two cavities. Induction heating devices of this type can be used to heat stationary or moving material and can be integrated into components or machines or household appliances, for civil, professional or industrial use.

### State of the Art

It is known that by subjecting a metallic element to a magnetic field which varies in space and/or time, electric currents are induced in the element itself; these electric currents are defined eddy currents (or Eddy currents) and in turn heat the metal element due to the Joule effect, which cooperates with the dissipative effect of reorientation of the magnetic domains known in literature as a typical and characteristic hysteresis cycle of materials ferromagnetic.

Numerous practical applications exploit this phenomenon. For example, the best known include the heating and the production of of pots on induction hobs electromagnetic brakes in some types of heavy vehicles.

In the typical applications of induction heating, the combination of an inductor element (hereinafter also referred to simply as “inductor”), emitter of electromagnetic waves, and induced element (hereinafter also referred to simply as “induced”), target metal of electromagnetic waves which converts electro-magnetic energy into thermal energy by the Joule effect. The electromagnetic field propagates in the air forming circular waves that close in on themselves; the presence of a ferromagnetic non-magnetic induced “attracts” the electromagnetic waves and favors an ordered deformation of the waves which preferably concentrate on it. To further favor the orientation of the electromagnetic waves towards the induced, it is customary 5 to place in contact with the inductor, specifically a pancake, a ferritic element, such as the “sweet ferrites”, capable of rejecting the field and directing it from opposite side; limiting the orientation of the field favors the maximum efficiency of electro-magneto-thermal conversion on the metallic non-magnetic armature, but the emitting thermal surface is limited to the one and only non-magnetic armature present. Furthermore, similar configurations are characterized by the presence of a fraction of dissipated thermal energy, not recovered by the inductor itself.

The aforementioned heat loss from the inductor can also and above all be found in the case of heating of flows inside chambers shaped like a tube or the like; in these cases, the wireless heating characteristic of the induction is used to arrange the electrical component, the inductor, outside the chamber, thus losing the fraction of residual heat generated on the inductor due to the Joule effect.

, not all materials with metallic behavior are suitable for making objects of practical interest that exploit this phenomenon. Some metals, called ferromagnetic, respond better to the magnetic fields generated at powers and frequencies compatible for civil or industrial use in the context of the phenomenon described above, returning a magnetothermic conversion factor greater than 90%. These metals have a magnetic permeability much higher than 1.

The following table 1 summarizes the classification.

TABLE 1

| | relative magnetic |
|---|---|
| Metal | permeability |
| Ferromagnetic | μᵣ >> 1 |
| Diamagnetic | μᵣ < 1 |
| Paramagnetic | μᵣ > 1 |

The difference between the relative magnetic permeability values of paramagnetic metals compared to diamagnetic metals is minimal and often negligible for practical purposes, in particular with regard to induction heating.

The ferromagnetic metals, which at room temperature respond to electromagnetic fields, are iron, cobalt and nickel. Some rare earths are ferromagnetic at temperatures even much lower than ambient temperature.

Regardless of the classification just summarized, for simplicity in the description that follows, paramagnetic metals and diamagnetic metals will simply be defined as non-magnetic or non-magnetic or non-ferromagnetic metals, like metals that in general do not interact appreciably with magnetic fields, including it is possible to mention for example aluminum, copper, zinc, brass, bronze, titanium, steel, stainless steel, austenitic steel, inconel, gold, silver, hastelloy . . . .

However, these metals represent excellence in the industrial, civil and professional market, above all
for corrosion resistance—by way of example: Hastelloy, Inconel and austenitic stainless steels defined AISI according to the American nomenclature (American Iron and Steel Institute) of the AISI 2XX and 3XX series. For example: AISI 201, AISI 202, AISI 208, AISI 316 and AISI 316L, AISI 304, AISI 321, AISI 347, . . . .
for thermal conductivity (for example aluminum, copper, silver, gold . . . )
for biocompatibility (for example: titanium grade 1, 2, 3,4)

The application of induction to ferromagnetic metals alone is therefore reductive. Iron rusts easily, nickel creates allergies, cobalt is expensive and toxic.

However, induction on non-ferromagnetic metals is not practiced today due to problems related to:
1) Emission of electromagnetic waves in the air at civil frequencies, low voltage. Diamagnetic and paramagnetic metals “capture”, convert a percentage of electromagnetic waves much lower than 85% into thermal energy, the remainder is dispersed in the air causing interference, electrosmog, . . . .
2) low degree of coupling inductor (the inductor crossed by electric current and emitter of electromagnetic waves) and the non-magnetic armature (the metal where the electric current induced by the inductor circulates). The lack of adequate coupling values compromises the functionality of the oscillator (i.e. part of the electronic board responsible for generally the voltage or variable power current that generates the heating) so much that a coupling sensor is inserted which inhibits the oscillator from switching on. in case of inadequate coupling values.

In the industrial and civil field, the heating of flowing or stationary material (solid or liquid or gaseous) occurs mainly with the use of electrical resistances immersed in the flow. The electric resistances return an efficiency close to 100%, however they are equipped with a small exchange surface which severely limits the heat transfer. Furthermore, to accelerate the heating process, the temperature of the resistances is raised which however could damage the flowing/stationary material in contact and/or cause a profound difference between the temperature of the resistance and that of the flowing or stationary material, forcing to choose only one of the two temperatures to be measured and controlled.

Induction has the advantage of being able to be applied to large surfaces and would allow a more extensive heating of the flowing or stationary material with a more accurate temperature control. However, ferromagnetic metals do not often represent a viable solution due to intrinsic chemical-physical limits (for example oxidation, corrosion, food incompatibility . . . ).

It is therefore desirable to be able to overcome the limits described above to also exploit non-magnetic metals in all practical applications that involve heating caused by eddy currents induced by magnetic fields.

It is also desirable to make a non-magnetic induction heating device based on the use of such non-magnetic metals.

Finally, it is desirable to realize the non-magnetic induction heating device in such a way as to make it integrable or associable in different elements, for example in elements for heating fluids (such as for example water, air, steam, oil . . . ) or solids (such as for example powders, grits, pipes . . . ) stationary or in motion, so as to provide the possibility of having a non-visible and/or non-intrusive heating.

### SUMMARY OF THE INVENTION

The object of the present invention is therefore to obtain an induction heating device 100 capable of solving one or more of the problems mentioned above.

An embodiment of the present invention can refer to an induction heating device 100 for flowing or stationary materials, comprising: at least one inductor element 20, at least two induced elements, 10 and 30, and at least two cavities 15 and 35 present respectively between the induced element 10 and the inductor 20 and the induced element 30 and the inductor 20, where the induced elements 10 and 30 consist of at least one non-ferromagnetic metal or at least one non-ferromagnetic metal mixture.

Thanks to this form of implementation, the lines of force emitted by the inductor are effectively absorbed and converted into thermal energy on the non-ferromagnetic metal or non-ferromagnetic metal alloy armatures; the double or multiple presence of the non-ferromagnetic induced, in fact, modifies the electromagnetic field and prevents it from escaping, transforming the electromagnetic waves into thermal energy with conversion efficiency even higher than 85% and considerably increasing the heat exchange surface between the emitter (the non-ferromagnetic armatures 10 and 30) and the flowing and/or stationary material. Thanks to this embodiment it is therefore possible to realize a compact induction heating device 100 with double or multiple emitting thermal wall which can be advantageously integrated in different devices or materials and/or which can be advantageously applied to polyhedral or curved surfaces, possibly having a variable radius.

In one embodiment the device 100 has a planar development (FIG. 1a and FIG. 3a) or tubular with a polyhedral or circular or oval section (FIG. 1b and FIG. 2a). Thanks to this embodiment, the device 100 is easily adaptable to different applications.

In one embodiment, the material to be heated flows or stands in the interspace 15 and/or 35; where possible, the material to be heated can also flow or stay in the interspace 45. Thanks to this embodiment, the material can exchange large amounts of heat at low temperatures, also recovering the residual heat fraction usually dispersed on the inductor.

In one embodiment, the material to be heated flows or stays in contact with the non-magnetic armature 10 and 30 on the opposite side of the air spaces 15 and 35; thanks to this form of implementation, the material can exchange large amounts of heat at low temperatures and the inductor does not limit the possible applications of the device 100 or it contaminates or is contaminated by the material itself.

In one embodiment, the gaps 15 and/0 35 have a distance from the non-magnetic armature 10 and the inductor 20 and from the inductor 20 and the non-magnetic armature 30 of less than 1000 mm, preferably 5 mm and 20 mm; The distance can be constant or vary along the development of the armatures, coming to touch the inductor in case of bent and/or embossed and/or cut armatures; thanks to this form of implementation it is possible to make the material to be heated flow or station in the cavities, giving specific thermal dynamics required by the process.

In one embodiment the inductor 20 is a common electrical conductor consisting of one or more copper or aluminum wires or micro-wires, usually vitrified and/or possibly coated with a dielectric resistant to temperatures above 100° C. such as mylar, silicones, technical resins, ceramics or equivalent. However, the choice of the type and conformation of the inductor (type of wire, shape, order and turns) that best matches the conformation of the armatures and the choice of the dielectric insulator that covers the inductor wires are left to the expert's knowledge in order to avoid short circuits or damage to the inductor itself during its use.

In one embodiment the inductor 20 is of a solenoidal shape with a cylindrical or polygonal geometry or a planar spiral of a circular or polygonal or elliptical shape. According to the conformation of the apparatus 100 it will therefore be possible to select the optimal conformation for the application requirements.

In one embodiment the inductor 20 is supported in the correct conformation and in its seat by a soft or rigid support and/or by adhesive elements as in traditional applications, available on the market.

In one embodiment the inductor 20 can be repeated n times, with n greater than 2, connected singly or in series or in parallel to an oscillator or more oscillators. Thanks to this form of implementation it is possible to realize large-sized devices by resorting to the advantages of a modular construction using standardized components.

In one embodiment the non-magnetic armature 10 and the non-magnetic armature 30 are placed at a distance from the inductor 20 comprised between 0.1 mm and 1000 mm, preferably between 0.5 mm and 20 mm. Thanks to this embodiment it is possible to maximize the electromagnetic coupling between the armatures 10 and 30 and the inductor 20 and to provide hollow spaces 15 and 35 for the passage or stationing of the material to be heated of a suitable size for the purpose of the device.

In one embodiment the non-magnetic armature 10 and the non-magnetic armature 30 are containers such as, for example, conduits with a non-ferromagnetic metal polyhedral section; thanks to this form of implementation it is possible to heat several elements at the same time, for example several pipe sections.

In one embodiment the distance A1 of the non-magnetic armature 10 from the inductor 20 and the distance A3 of the non-magnetic armature 30 from the inductor 20 are equal or dissimilar; thanks to this form of implementation it is possible to drive the flow of the electromagnetic field towards the innermost or outermost non-magnetic armature or to balance them.

In one embodiment the non-magnetic armature 10 and/or 30 consists of a non-ferromagnetic metal or a non-ferromagnetic metal alloy such as aluminum, zinc, brass, bronze, copper, titanium, austenitic steel, paramagnetic steel, diamagnetic steel, silver, gold, inconel, hastelloy.

Thanks to this form of implementation in the case of excellent thermal conductors such as aluminum and copper, it is possible to favor the rapid transfer of thermal energy to the moving or stationary material in the cavities 15 and 35, at the same time favoring a considerable homogeneity of heat transfer. In case of bad heat conductors such as steel, titanium, inconel and hastelloy it is possible to reach high heat exchange temperatures, keeping the physical and mechanical characteristics unaltered.

In one embodiment the non-magnetic armature 10 and/or 30 have the same or different composition. Thanks to this form of implementation it is possible to homogenize or differentiate the thermomechanical and heat transfer characteristics of the armatures 10 and 30, making the device 100 capable of locally differential performances.

In one embodiment, the armatures 10 and/or 30 have a thickness comprised between 6 micrometers and 10000 micrometers, preferably between 6 and 1000 micrometers; thanks to this embodiment the device 100 is rigid or flexible.

In one embodiment the armatures 10 and 30 have equal or similar or dissimilar thickness; thanks to this form of implementation it is possible to design devices with high efficiency of electro-magneto-thermal conversion.

In one embodiment the armatures 10 and/or 30 are flat, embossed or perforated; thanks to this form of implementation it is possible to facilitate the passage of the material or to maximize the heat exchange surface by increasing the surface of the non-magnetic armature 10 and/or 30, as for example in the case of embossing or drilling of the non-magnetic armature 10 and/or 30.

In one embodiment, the armatures 10 and/or 30 are coupled to insulating and/or metal supports which give the armature(s) mechanical and/or thermodynamic properties, but which do not contribute to their improvement of the electromagnetic-thermal conversion with the ‘inductor. Said supports can be hermetically or weakly coupled totally or at least partially to one of the armatures. By way of example, the coupled supports can be embossed, ribbed, perforated, with three-dimensional mesh, with fins . . . to facilitate heat exchange, the passage of the material, strengthen the armatures, especially in the case of armatures consisting of thin sheets. Thanks to this form of implementation, the armatures 10 and/or 30 improve or alter the mechanical properties of resistance and/or friction and/or corrosion and/or accumulation of heat and/or heat exchange, . . . .

In one form of implementation, the armatures 10 and/or 30 can be flanked by further armatures 61, 62, 63 . . . and/or 81, 82, 83 . . . to form distinct and galvanically separated sheets, parallel or concentric in case of conformation of the laminar or cylindrical device 100, and spaced from each other by gaps 16, 17, 18 . . . and/or 36, 37, 38 . . . ; thanks this form to of implementation, any electromagnetic field fractions not absorbed and converted into heat by the non-magnetic armature 10 and/or 30 can be conveniently absorbed and converted by the armatures 61, 62, 63 . . . and/or 81, 82, 83 . . . . Furthermore, again thanks to this form of implementation, it is possible to further increase the exchange surface, thus lowering the heat transfer temperature, reducing the turbulence of the material flow (in the event that this is a fluid).

In one embodiment, the non-magnetic inducts have different thickness, shape and/or chemical composition. Thanks to this form of implementation it is possible to realize devices 100 which better adapt to the heating needs of the stationary or flowing material.

In one embodiment the non-magnetic armature 10 and/or 30 consists of several plates galvanically joined together (eg composite material) or by a single continuous plate folded back on itself. Thanks to this form of implementation, the fraction of the electromagnetic field advantageously absorbed and converted into heat is maximized.

In one embodiment the non-magnetic armature 10 and/or 30 is represented by an embossed and/or folded and/or perforated sheet, possibly folded back on itself, creating discontinuous cavities 15 and/or 35. Thanks to this form of implementation, the material flowing in the cavities 15 and 35 has very low levels of turbulence and very high heat exchange surfaces.

In one embodiment the non-ferromagnetic armature 10 and/or 30 can be favorably coupled to a thermal insulator 50 on the opposite side of the cavities 15 and/or 35 and thanks to which the fraction of thermal energy dissipated in the opposite direction is limited so that's useful for the stationing or flow of the material present in the cavities 15 and/or 35.

In one embodiment, the material present in the interspace 15 and/or 35 is a solid or a liquid or a suspension or a colloidal suspension or a gel or a gas or a mixture of at least two of these, which transits or stays temporarily undergoing processes of heating, firing, hardening, crosslinking, phase and/or state change, thermolysis, . . . . By way of example, indicative and not limiting, the solid material in transit or stationary can be represented by chemical, food, inert substances, polymeric, silicone, elastomeric, composite and/or greasy elements . . . . In the case of a solid element, it can be presented in powder or pastes or granules or pellets or as a monolithic element with a single layer or multiple layers.

By way of example, indicative and not limitative, the material with a prevalent liquid composition can be represented by water, oils, milk, alcohol, yogurt, wine, beers, fuels, inks, solvents, glues, liquid metals, molten salts, lubricants and/or cosmetics . . . .

By way of example, indicative and not limiting, the gaseous material can be represented by steam, natural gas, air, nitrogen, oxygen and/or technical gases . . . .

In one embodiment the device 100, the armatures 10 and 30 and the inductor 20, depending on the application, conveniently have identical or dissimilar characteristic dimensions; thanks to this form of implementation it is possible to create a device that best achieves the specific service expected without wasting space and energy.

In one embodiment the device 100 is contained within a totally or partially closed chamber (e.g. a tube with open or closed bases, a parallelepiped container,). Thanks to this form of implementation it is possible to heat a small volume where the moving or stationary material can receive heat in at least 2 thermally emitting surfaces, the armatures 10 and 30.

In one embodiment the device 100 has a planar conformation, where the armatures 10 and 30 and the planar spiral-shaped inductor 20 lie on parallel or converging or diverging planes. Thanks to this form of implementation, the device 100 can be easily integrated into elements with a prevalently planar development, optimizing the overall dimensions available from the application.

In one embodiment, the armatures 10 and 30 and the inductor 20 can be arranged with mutually parallel or inclined axes. In the case, by way of example, the device 100 has a tubular conformation with a round or polygonal section, the armatures 10 and 30 and the solenoidal inductor 20 can be arranged concentrically, with parallel or mutually inclined axes. Thanks to this form of implementation it is possible to alter the caloric intake and/or the flow rate and/or the thermodynamic properties of crossing or stationing of the material to be heated.

By way of example, the tubular device 100 described above can allow the differentiated and simultaneous heating of two moving or stationary elements or it can be an integral part of concentric pipes where the non-magnetic armature 10 is the innermost pipe and the non-magnetic armature 30 the outermost one which includes the inductor 20 and the non-magnetic armature 10; Thanks to this form of implementation it is possible to proceed with a single compact device to the simultaneous heating of several elements and possibly to mix them only when certain temperatures are reached without loss of thermal energy during the transitions.

The advantages described above in relation to the device can also be obtained by using, as an alternative to metals and metal alloys, non-metallic materials which however exhibit metallic behavior, such as for example electroconductive technopolymers.

The present invention also relates to a method for heating a material through the aid of an induction device 100 composed of the following steps:
1) prepare a device 100 consisting of
   at least one non-magnetic induced element 10,
   at least one interspace 15
   at least one inductor 20
   at least one interspace 35
   and at least one non-magnetic armature 30

It is characterized in that the armatures 10 and 30 are composed of at least one non-ferromagnetic metal and at least one mixture of non-ferromagnetic metals.
2) Insert the material in contact with the armatures 10 and 30 in the cavities 15 and/or 35 or in the part opposite to the cavities.
3) connect the inductor 20 to a suitable oscillator
4) activate the oscillator so that the appropriate electric current is applied to the Inductor 20

Thus, due to the phenomenon of electromagnetic induction, the armatures 10 and 30 are heated by the Joule effect and thus heat the material contained in the interspace 15 and/or 35.

Non-magnetic induction heating devices of this type can be used to heat solids and/or liquids and/or gases that are stationary or moving, where the non-magnetic heating device is placed or integrated into components or machines in civil, professional or industrial processes.

### LIST OF FIGURES

Further characteristics and advantages of the invention will be better highlighted by examining the following detailed description of a preferred but not exclusive embodiment, illustrated by way of non-limiting example, with the support of the attached drawings, in which:

FIG. 1a schematically shows a sectional view of a non-magnetic induction heating device 100 according to one of the embodiments of the present invention;

FIG. 1b schematically shows a sectional view of a duct non-magnetic induction heating device 100 according to one of the embodiments of the present invention with polynomial section (in the figure with 4 sides);

FIG. 2a schematically shows a three-dimensional view of a non-magnetic induction heating device 100 composed of non-magnetic armature 10, inductor 20 and non-magnetic armature 30 with circular section and tubular development;

FIG. 2b shows a three-dimensional view of a non-magnetic induction heating device 100 where the inductor element is repeated 3 times along the main axis of development of the entire device 100;

FIG. 3a schematically shows a three-dimensional view of a single-module, planar induction non-magnetic heating device 100.

FIG. 3B schematically shows a three-dimensional view of a planar modulus non-magnetic induction heating device 100 where the inductor 20 is replicated by way of example 3 times.

FIG. 4a schematically shows a top view of a non-magnetic induction heating device 100 in which the non-magnetic armature 10 and the non-magnetic armature 30 are bent plates, and the non-magnetic armature 10 is repeated to form a double plate;

FIG. 4b schematically shows a top view of a non-magnetic induction heating device 100 in which the non-magnetic armature 10 and the non-magnetic armature 30 are bent plates, and the non-magnetic armature 10 is repeated to form a double plate; the device is contained in a chamber 50.

FIG. 5a schematically shows a vertical section of an induction non-magnetic heating device 100 in which the non-ferromagnetic armature 10 and the non-ferromagnetic armature 30 follow respectively armatures 61, 62, 63 spaced by cavities 16, 17, 18 and/or induced 81, 82, 83, spaced by cavities 36, 37, 38.

FIG. 5b schematically shows half of a vertical section of an induction heating device 100.

FIG. 6a and FIG. 6b schematically show respectively a top view and a three-dimensional view of a non-magnetic induction heating device 100 with tubular development characterized by, starting from the center, an internal section 45, the non-magnetic armature 10, a gap 15, an inductor 20, a gap 35 and a non-magnetic armature 30.

### DETAILED DESCRIPTION OF THE INVENTION

The present invention refers to a non-magnetic heating device 100 comprising at least one inductor element 20, at least two induced elements 10 and 30, monolithic or multilayer with stratigraphy with metallic behavior and at least two cavities 15 and 35 and is characterized in that the induced elements 10 and 30 consist of a non-ferromagnetic metal or a non-ferromagnetic metal alloy.

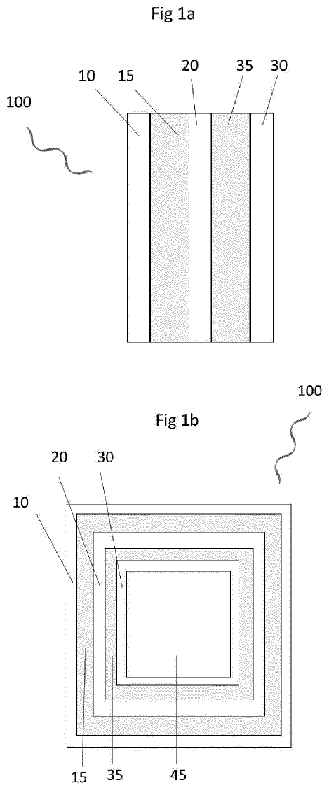

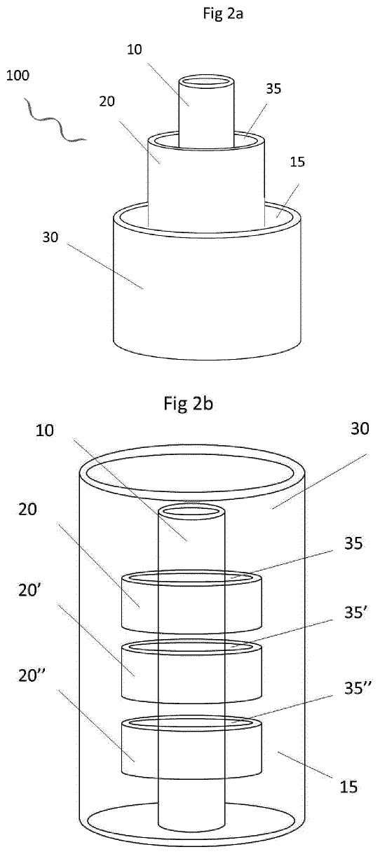

FIG. 1a and FIG. 2 shows two forms of implementation of the present invention.

FIG. 1a describes a device 100 comprising at least one inductor element 20, at least two induced elements, 10 and 30, monolithic or multilayer with metallic behavior stratigraphy and at least two air spaces 15 and 35 and is characterized in that the induced elements 10 and 30 consist of a non-ferromagnetic metal or a non-ferromagnetic metal alloy.

In one embodiment, the non-magnetic induction heating device 100 has a concave or convex development; in FIG. 1b the device 100 the angle of curvature is complete and the device 100 is shaped, by way of example, like a tube with a rectangular section.

FIG. 1b shows the device 100 consisting of:
non-magnetic armature 10 positioned in the outermost layer and directly bordering the interspace 15
cavities 15 and 35, cavities within which the liquid or solid to be heated is stationed or flows.
inductor 20, central to the device
non-magnetic armature 30 hollow inside, with cavity 45.

The interspaces 15 and 35 and the cavity 45 can house one or more materials to be heated, liquids and/or solids. Furthermore, by acting on the distances of the non-magnetic armatures 10 and 30 from the inductor 20, it is possible to differentiate the heating temperatures of the material present in the cavities 15 and/or 35 and/or in the cavity 45, using a single oscillator, without resorting to complex regulation systems temperature. This is made possible only through the non-magnetic induction heating device 100 since the particularity of the response to the electromagnetic fields of the non-magnetic armatures and the deformation of the resulting electromagnetic field affects the distances and the degree of coupling of the same to the oscillator, causing a control the degree of excitation of the induced and its heating.

The armatures 10 and/or 30 have a thickness between 6 and 10000 micrometers, preferably between 6 and 1000 micrometers and at last one of them is in non-magnetic metal such as aluminum, titanium, zinc, copper, non-magnetic metal alloy such as steel, bronze, hastelloy, inconel, aluminum alloys, copper alloys, titanium alloys.

The non-magnetic heating device 100 can assume a planar or duct shape and preferably assumes a cylindrical shape with a diameter from 1 centimeter to 1 meter or more generally a surface xy of less than 5 m2.

FIG. 2A shows an exploded view of the device 100 with circular section and tubular development. In FIG. 2A the first armature 10 is inserted inside the solenoidal inductor 20 while the second armature 30 is placed outside it. The air spaces 15 and 35 separate the inductor 20 from the armatures 30 and 10. The armatures 10 and 30 and the inductor 20 can lie on the same xy plane or be misaligned.

In FIG. 2B the inductor 20 is present as a series of solenoidal inductors (20, 20′ and 20″), separated from each other which can be joined in series or parallel to a single oscillator or can be independent of each other and connected to single oscillators. The distance between one inductor and another can be between 1 mm and 50 mm.

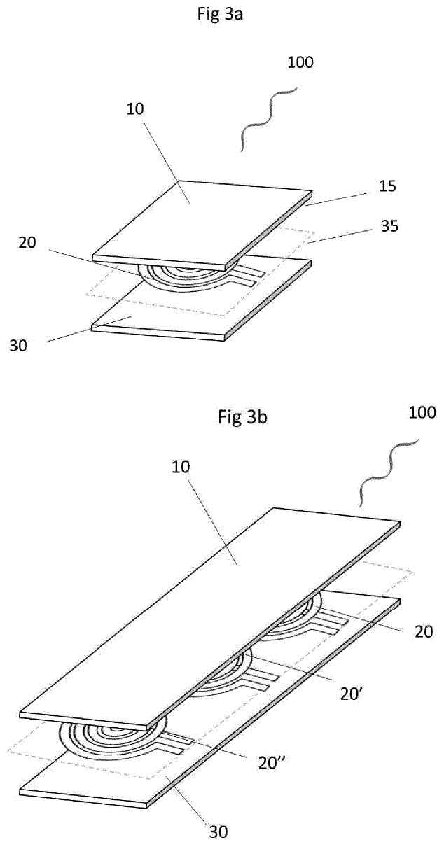

FIG. 3A schematically represents the device 100 in planar form with a single module, i.e. composed of an armature 10, an armature 30, an inductor 20 and two cavities, 15 and 35. FIG. 3B shows an implementation form of the present invention in which the device 100 in planar form has several pancake inductors 20 (20, 20′ and 20″), separated from each other, and which can be joined in series or parallel to a single electronic power board or can be independent one from the other and connected to single power boards. The distance between one inductor and another can be between 1 mm and 50 mm.

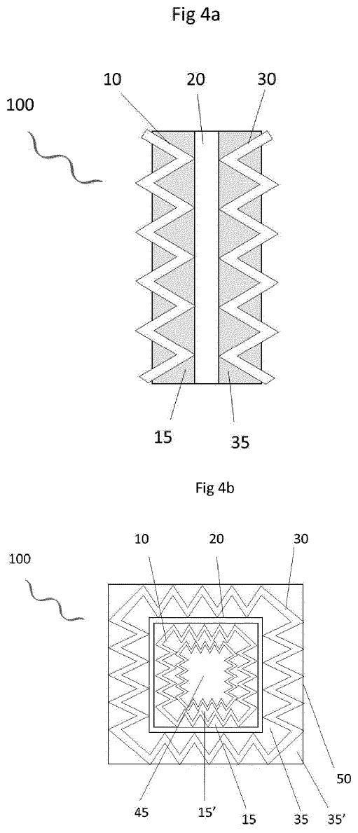

In one embodiment one or both of the armatures 10 and/or 20 are folded and/or embossed foils. FIG. 4A shows a top view of the device 100 where the armatures and inductor have a tubular development with a square section and in which both armatures 10 and 30 consist of at least one sheet folded to form an accordion.

In one embodiment, the armatures 10 and/or 30 can be constituted by several plates as in the case of FIG. 4b where the armature 30 is a plate folded like an accordion and the armature 10 is represented by 2 plates folded like an accordion which can appear united or disjoint, separated by a dielectric. In FIG. 4B the device 100 is finally inserted inside a chamber 50 which allows the containment of the stationary or moving material. Chamber 50 can have a circular, oval, curvilinear, square, rectangular or polygonal section (eg star, hexagonal . . . ).

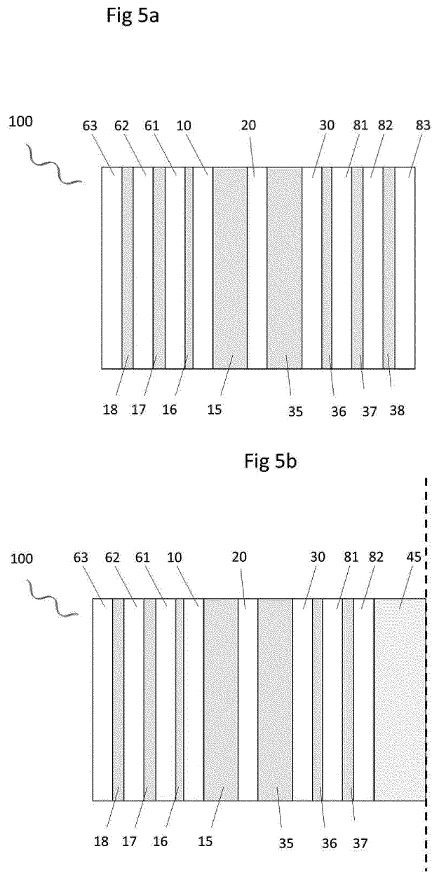

In one embodiment the device 100 is represented by several armatures separated by several air spaces. FIG. 5a shows a section of a device 100 consisting of:
armatures 63, 62, 61, 10 separated respectively from each other by the cavities 18, 17, 16.
armature 10 separated from the inductor 20 and from the armature 30 by the air spaces 15 and 35
armatures 83, 82, 81 and 30 separated respectively from each other by the cavities 38, 37, 36.

This form of implementation could allow a stratification of the temperatures on the different armatures.

FIG. 5b shows half section of a device 100 with multiple armatures 10, 61, 62, 63 and 30, 81, 82 and multiple cavities 15, 16, 17, 18 and 35, 36, 37 which repeats itself by symmetry from the side of the interspace 45 to form, by way of example, a tubular device 100 with circular, oval, curvilinear, square, rectangular or polygonal section.

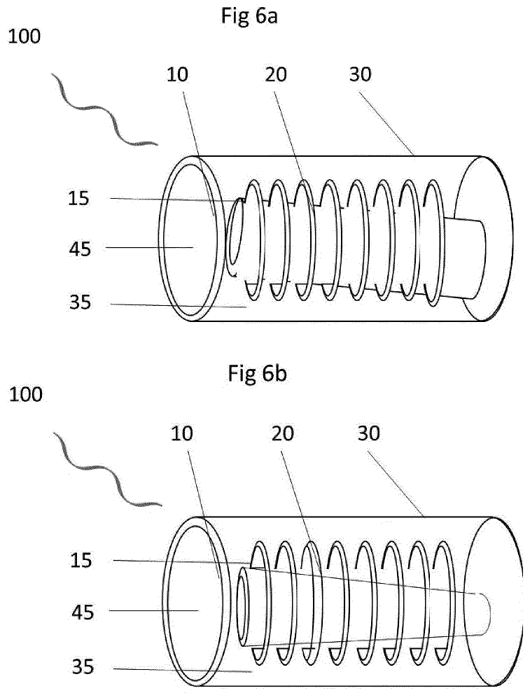

The armatures 10 and 30 and the inductor 20 can have different dimensions and developments. FIG. 6a schematically shows a device 100 with a tubular development with a circular section where the inductors 10 and 30 and the inductor 20 have a similar development. In FIG. 6b the extension of the armature 10 and 20 is tubular with a circular section, while that of the armature 30 is conical.

Although different forms of implementation have been described separately, it will be clear to those skilled in the art that they can be combined with each other, without necessarily combining all the characteristics of the same, but only those necessary to obtain a desired effect.

1. Induction heating device (100) comprising:
at least one induced element (10)
at least one inductor element (20)
at least one induced element (30)
at least a gap (15) placed between the induced element (10) and the inductor element (20)
and at least a gap (35) placed between the induced element (30) and the inductor element (20)
characterized in that
the induced element (10) and the induced element (30) comprise a non-ferromagnetic metal or a non-ferromagnetic mixture of metals and wherein the material to be heated, that transits or stays inside the gaps, is a solid or a liquid or a suspension or a gel or a gas or a mixture of at least two of these.

2. Induction heating device (100) according to claim 1 wherein the inductor element (20) is placed from the non-ferromagnetic induced element (10) and/or (30) at a distance between 0.1 mm and 1000 mm, preferably between 0.5 mm and 20 mm.

3. Induction heating device (100) according to claim 1, wherein the inductor element (20) consists in “n” inductor elements, with “n” greater than or equal to 2, connected individually or in series or in parallel to one or more oscillators.

4. Induction heating device (100) according to, claim 1, wherein the induced elements, (10) and (30), have a tubular conformation with a round or oval or polygonal section and the inductor element (20) has a solenoid conformation and inductor and induced elements are arranged concentrically with parallel or mutually inclined axes.

5. Induction heating device (100) according to claim 1, wherein the device (100) is contained within totally or partially closed chamber.

6. Induction heating device (100) according to claim 1, wherein the non-ferromagnetic induced element (10) and/or (30) consists of a non-ferromagnetic metal or a non-ferromagnetic metal alloy such as aluminum, zinc, brass, bronze, copper, titanium, austenitic steel, paramagnetic steel, diamagnetic steel, silver, gold, inconel, hastelloy.

7. Induction heating device (100) according to claim 1, wherein the non-ferromagnetic induced elements (10) and/or (30) have a thickness comprised between 6 micrometers and 10000 micrometers, preferably between 6 and 1000 micrometers.

8. Induction heating device (100) according to claim 1, wherein the non-ferromagnetic induced elements (10) and/or (30) are flat, folded, embossed and/or perforated.

9. Induction heating device (100) according to claim 1, wherein the device (100) consists of several non-ferromagnetic induced elements separated from each other by gaps.

10. Induction heating device (100) according to claim 1, wherein the non-ferromagnetic induced elements (10) and/or (30) consists of several sheets galvanically joined together or by a single continuous sheet folded back on itself.

11. Induction heating device (100) according to claim 1, wherein the non-ferromagnetic induced elements are different from each other in thickness, shape and/or chemical composition.

12. Induction heating device (100) according to claim 1, where in the non-ferromagnetic induced elements and/or the gaps have equal or dissimilar dimensions.

13. Induction heating device (100) according to claim 1, wherein the non-ferromagnetic inductors (10) and (30) and the spiral inductor (20) are planer and lie on parallel or converging or diverging planes.

14. Induction heating device (100) according to claim 1, wherein at least one of the induced elements is partially or integrally coupled to insulating and/or metal supports with solid or planar geometry and that are planar and/or embossed and/or ribbed and/or perforated.

15. Method for heating a material through an induction heating device (100) consisting of the following phases:
1) to prepare a device (100) consisting of
at least one non-magnetic induced element (10),
at least one gap (15)
at least one inductor (20)
at least one gap (35)
and at least one non-magnetic armature (30) and characterized in that the induced elements (10) and (30) are composed of at least one non-ferromagnetic metal and at least one non-ferromagnetic mixture of metals;
2) To insert the material into the gaps of the device (100);
3) to connect the inductor element (20) to a specific oscillator;
4) to activate the oscillator so that the appropriate electric current is applied to the inductor element (20).
